(19) United States
(12) Patent Application Publication
(10) Pub. No.: US 2010/0116113 A1
(43) Pub. Date: May 13, 2010

(54) Quick-assembly/disassembly mechanism of sawblade cover

(75) Inventor: Tian-Wang Wang, Taiping City (TW)

Correspondence Address: TIAN-WANG WANG, P.O. BOX 44-2049, TAIPEI, 10668, TW

(73) Assignee: MAO SHAN MACHINERY INDUSTRIAL CO., LTD.

(21) Appl. No.: 12/292,005

(22) Filed: Nov. 10, 2008

(51) Int. Cl. B26D 7/00

(52) U.S. Cl. 83/478

(57) ABSTRACT

The present invention provides a quick-assembly/disassembly mechanism for the sawblade cover of a wood sawing machine, which permits to install shields and stoppers correspondingly on both sides of a U-shaped supporting rod, and arrange a mobile damper within the supporting rod; moreover, when the quick-disassembly poker of the mobile damper is disassembled or assembled into the entire cover assembly, the poker is pulled up or pressed down to realize quick screwing and releasing of the cover assembly.

### BACKGROUND OF INVENTION

(1) Field of the Invention

The present invention relates generally to a -quick-assembly/disassembly mechanism of sawblade cover, and more particularly to an innovative one which enables quick disassembly of the cover by a mobile damper during operation, where necessary, and also quick positioning prior to operation, thereby improving the efficiency of the wood sawing machines.

(2) Description of The Prior Art

The sawing machine is a widely used machine for woodworking. Thanks to its advantages of high strength and adjustability of height, the saw blade can be applied to saw any kind of timber. But, the saw blade must be maintained or replaced frequently during continuous processing, especially when the saw blade is covered with sawdust. Otherwise, the sawing efficiency of saw blade will be adversely affected, thus leading to rapid tear-and-wear.

Whenever the saw blade is maintained or replaced, the shield of saw blade must be firstly dismantled, and then reassembled and fixed, which will spend more time and affect the efficiency, and also bring about safety hazard of operators, making it necessary for improvement.

### SUMMARY OF THE INVENTION

The inventor has developed and improved the present invention to meet the requirements for maintenance and replacement of sawblades of wood sawing machines. While a mobile damper is installed within the supporting rod of the cover, a quick-disassembly poker is operated to be lifted and pressed down easily based on the screwing or releasing characteristic of a nut, such that the efficiency of entire cover can be improved quickly in relation to the disassembly and positioning of the support frame.

### BRIEF DESCRIPTION OF THE DRAWINGS

FIG. 1 shows an assembly view of the wood sawing machine and cover assembly of the present invention.

FIG. 2 shows an assembly status view of the cover assembly of the present invention.

FIG. 3 shows an exploded perspective view of the cover assembly of the present invention.

FIG. 4 shows a schematic view of the present invention that the supporting rod is mated with the support frame.

FIG. 5 shows a schematic view of the mobile damper of the present invention when tightened.

FIG. 6 shows a schematic view of the present invention that the supporting rod is disengaged from the support frame.

FIG. 7 shows a schematic view of the mobile damper of the present invention when released.

### DETAILED DESCRIPTION OF THE PREFERRED EMBODIMENTS

The features and the advantages of the present invention will be more readily understood upon a thoughtful deliberation of the following detailed description of a preferred embodiment of the present invention with reference to the accompanying drawings.

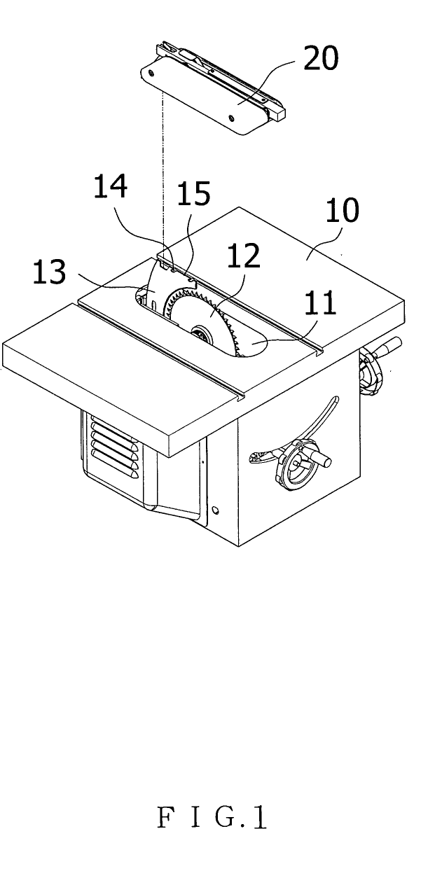

Referring to FIG. 1—assembly view of the wood sawing machine and cover assembly, wherein the wood sawing machine 10 allows a set of sawblade 12 to be placed in the preset saw cut 11 of the sawing machine; and a fixed support frame 13 is arranged at rear side of the sawblade 12; notched grooves 14, 15 for mating with the cover assembly 20 are formed at the upper side of the support frame 13.

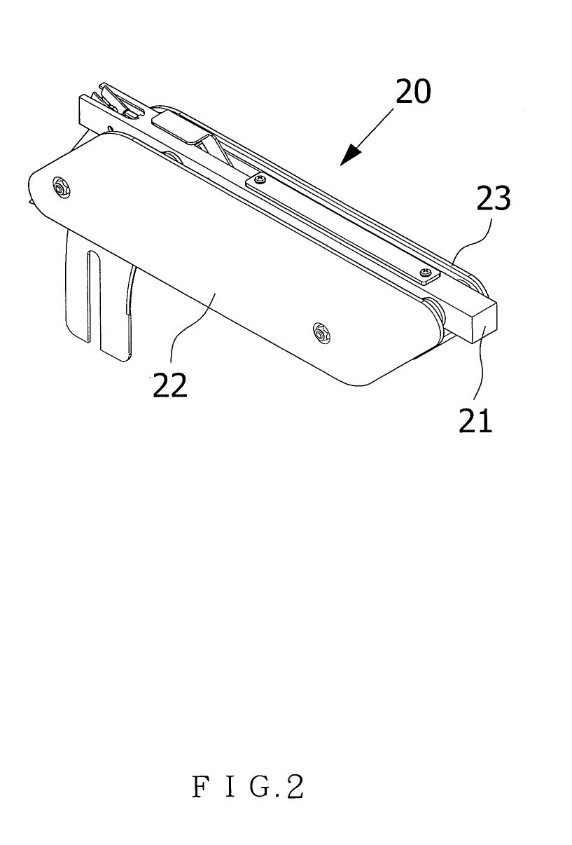

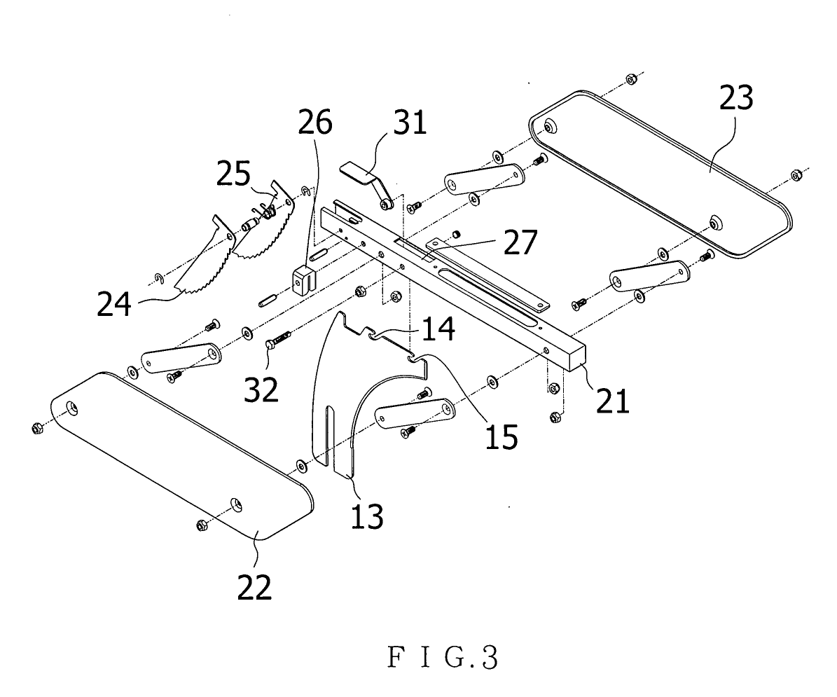

Referring also to FIGS. 2, 3, the cover assembly 20 comprises a U-shaped supporting rod 21, two shields 22, 23 at both sides and two stoppers 24, 25 at rear side of the shield; with this design, the shields 22, 23 for protecting the personal safety and the stoppers 24, 25 for preventing the setback force occurred during sawing process are integrally combined with the supporting rod 21.

In the U-shaped space, the supporting rod 21 allows to install a clamping block 26 with downward gripping mouth and a mobile damper 30 correspondingly to the notched grooves 14, 15 on the support frame 13; the mobile damper 30 is screwed onto the supporting rod 21 via a bolt 32, and coupled securely with a bearer 34 at the other end; in the U-shaped space of the supporting rod 21, the bolt 32 is mated with a nut 33 and a quick-disassembly poker 31, of which the quick-disassembly poker 31 is mated with the bolt via a spiral portion 312, and a poking rod 311 is protruded from the spiral portion 312 until reaching the exterior of the through-hole 27 of the supporting rod 21.

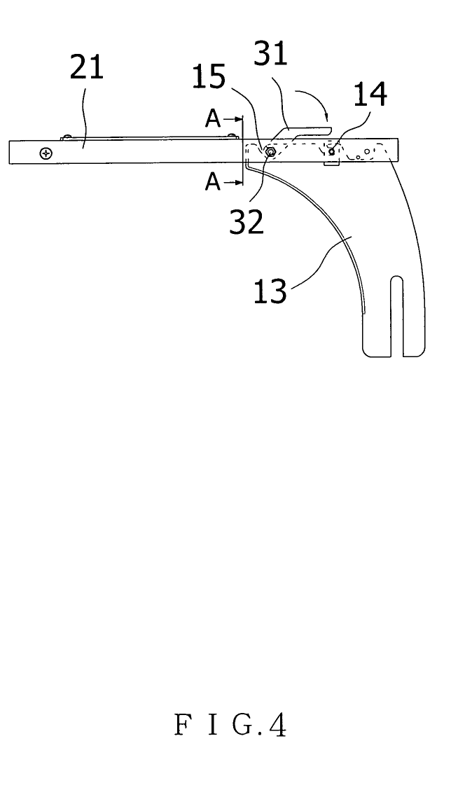

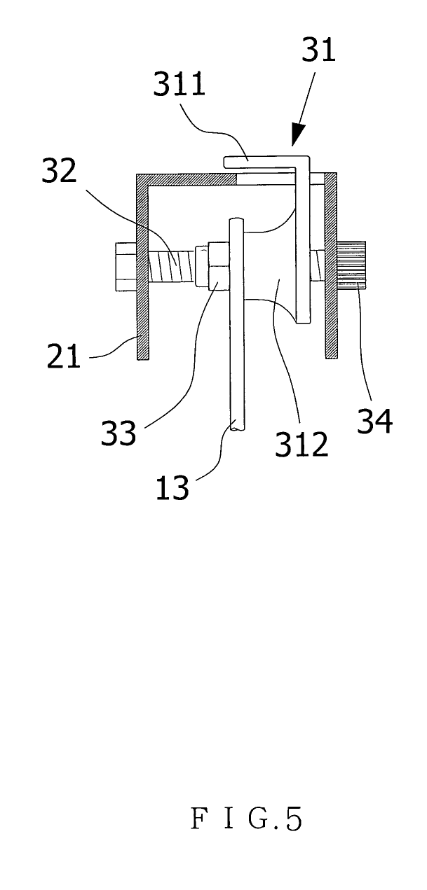

Referring also to FIGS. 4, 5, of which, FIG. 5 is the AA cross-sectional view of FIG. 4, when the cover assembly 20 is mated with the support frame 13, the clamping block 26 is locked in the rear notched groove 14 of the support frame 13, and the bolt 32 locked in the front notched groove 15 of the support frame 13; in such case, the front notched groove 15 is placed between the quick-disassembly poker 31 and nut 33; by pressing down the poking rod 311 of the quick-disassembly poker 31, the spiral portion 312 is screwed inwards via the screw thread of the bolt 32, so as to clamp the upper notched groove 15 of the support frame 13. In this way, the cover assembly comprising supporting rod 21, shields 22, 23, and stoppers 24, 25 are fixed on the wood sawing machine.

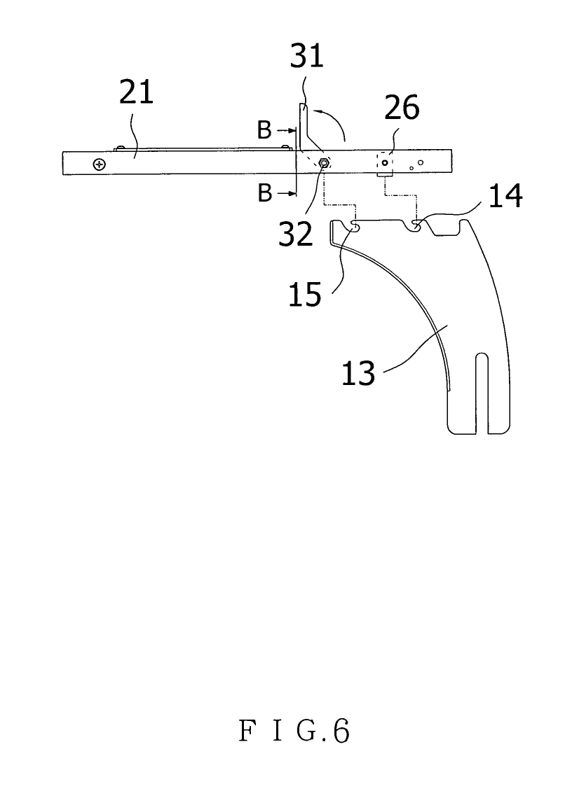

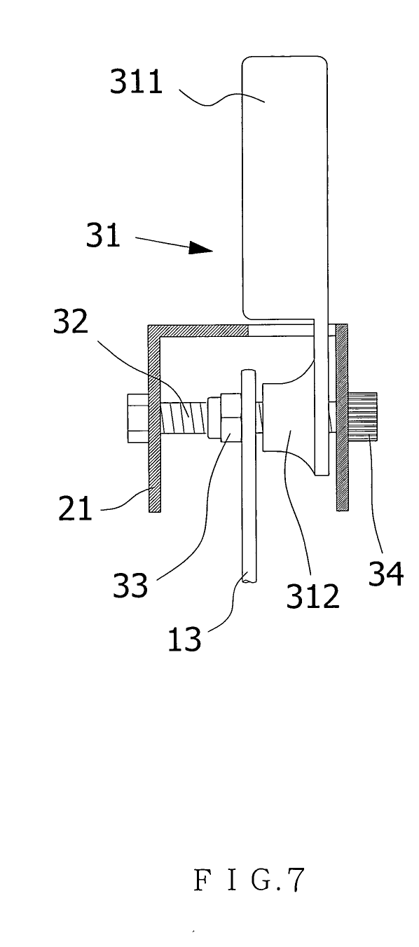

Referring also to FIGS. 6, 7, of which, FIG. 7 is the AA cross-sectional view of FIG. 6, if the poking rod 311 of the quick-disassembly poker 31 is pulled upwards, the spiral portion 312 is disengaged outwards, thus releasing the clamping force against the notched groove 15 of the support frame 13; so, the operator may remove easily the entire cover assembly comprising the shields 22, 23 and stoppers 24, 25, along with the supporting rod 21.

Thus, the shields 22, 23 and stoppers 24, 25 of the cover assembly are prefabricated onto a U-shaped supporting rod 21; a clamping block 26 and a mobile damper 30 are mated with or disengaged from the support frame 13 on the wood sawing machine, so that the entire cover assembly can be disassembled and positioned easily by the quick-disassembly poker 31, helping to improve the working efficiency and guaranteeing greatly the personal safety.

What is claimed is:

1. A quick-assembly/disassembly mechanism of sawblade cover, comprising a cover assembly containing a supporting rod, shields and stoppers; a support frame fixed on the sawing machine; U-shaped space of the supporting rod is provided with:
a clamping block with downward gripping mouth, which is placed correspondingly to the notched grooves on the support frame;
a mobile clamper, which is screwed onto the supporting rod via a bolt, and coupled securely with a bearer at the other end; in the U-shaped space of the supporting rod, the bolt is mated with a nut and a quick-disassembly poker; the bolt between the quick-disassembly poker and nut is locked in the front notched groove of the support frame;
by pulling and pressing the quick-disassembly poker, the positioning or disassembly of the cover assembly for the support frame can be realized.

2. The quick-assembly/disassembly mechanism defined in claim 1, wherein the shields and stoppers are prefabricated on the supporting rod.

3. The quick-assembly/disassembly mechanism defined in claim 1, wherein the quick-disassembly poker is mated with a bolt via a spiral portion.

4. The quick-assembly/disassembly mechanism defined in claim 1, wherein a poking rod is protruded from the quick-disassembly poker until reaching the exterior of the supporting rod.
